(19) United States
(12) Patent Application Publication
(10) Pub. No.: US 2009/0235043 A1
(43) Pub. Date: Sep. 17, 2009

(54) AUTOMATIC TABLE PARTITIONING ROLL-IN

(76) Inventors: Peeyush Jaiswal, Boca Raton, FL (US); Vikram S. Khatri, Durham, NC (US); Burt L. Vialpando, Irving, TX (US)

Correspondence Address: HOFFMAN WARNICK LLC, 75 STATE ST, 14 FL, ALBANY, NY, 12207, US

(21) Appl. No.: 12/049,627

(22) Filed: Mar. 17, 2008

(51) Int. Cl. G06F 12/00

(52) U.S. Cl. 711/173; 711/E12.001

(57) ABSTRACT

A system, method and program product for automatically partitioning tables in a database system. A partitioning system is provided that includes: a system for analyzing a plurality of partition settings that predefines partitioning operations that need to occur in the future; and an automatic partition roll-in system that automatically causes tables to be partitioned based on the partition settings.

### FIELD OF THE INVENTION

This disclosure relates to table partitioning in a database, and more particularly relates to a system and method of providing automatic table partitioning roll-in.

### BACKGROUND OF THE INVENTION

Partitioned tables require due diligence from a database administrator (DBA) to make sure the partitions are defined such that data loaded into these tables do not fall outside the scope of the partitions themselves. If the data being loaded falls outside a partitioning scope, data could be lost. In order to make sure this does not happen, DBAs have to do what is called a “partition roll-in” to provide a place for new data to go. DBAs that maintain partitioned tables in their databases have to do a number of manual process steps and decision points to make in order to do the partition roll-in and avoid this problem:

First, they have to make reminders for themselves in a maintenance calendar of their own making. Some do it every week, month or quarter. Some only do it once they experience a problem in a partition somewhere else in the database that “reminds” them they need to attend to their table partitions.

Next, they have to review the partition situation manually or at best, review a report or some SQL they have created themselves to see what their partition situation looks like.

After reviewing this report or SQL output, they may determine a new partition is required for a table (because data is being loaded into the last partition already). They are then faced with the decision to roll-in one or many partitions. A roll-in of only one partition means that the DBA will have to review this situation again on the very next cycle. This has the advantage of only allocating disk space required for the current cycle. A roll-in of many partitions means that they can put off a roll-in of partitions for more cycles. But this has the disadvantage of using up more disk pace that is set aside and not used for that entire time.

Accordingly, partition roll-in a costly DBA maintenance activity. It has multiple failure points and has a downside no matter what the DBA decides to do. This is the case for most relational database management systems (RDBMS) that support table partitioning, like DB2, Oracle and so on, so this is a universal problem.

Accordingly, a need exists for a more robust solution to dealing with table partitioning in a database.

### SUMMARY OF THE INVENTION

In one embodiment, there is a partitioning system for automatically partitioning tables in a database system, comprising: a system for analyzing a plurality of partition settings that predefines partitioning operations that need to occur in the future; and an automatic partition roll-in system that automatically causes tables to be partitioned based on the partition settings.

In a second embodiment, there is computer readable medium having a computer program product for automatically partitioning tables in a database system, comprising: program code for analyzing a plurality of partition settings that predefines partitioning operations that need to occur in the future; and program code that automatically causes tables to be partitioned based on the partition settings.

In a third embodiment, there is a method for automatically partitioning tables in a database system, comprising: receiving a plurality of partition settings that predefine partitioning operations that need to occur in the future; analyzing the plurality of partition settings; analyzing a state of the database system; and automatically causing tables to be partitioned based on the partition settings and the state of the database system.

This thus allows a database system to “notice” that data has been loaded into the last partition of a partitioned table and then automatically roll-in the next partition by itself. This maximizes disk usage and protects the database system from data loss or load failures all without regular intervention. It also reduces the total cost of ownership for database systems with partitioned tables.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings.

FIG. 1 depicts a computer system having a partitioning system in accordance with an embodiment of the present invention.

FIG. 2 depicts a table of partition settings in accordance with an embodiment of the present invention.

FIG. 3 depicts an explanation of the partition setting in accordance with an embodiment of the present invention.

FIG. 4 depicts a flow diagram of a method of implementing table partitioning in accordance with an embodiment of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

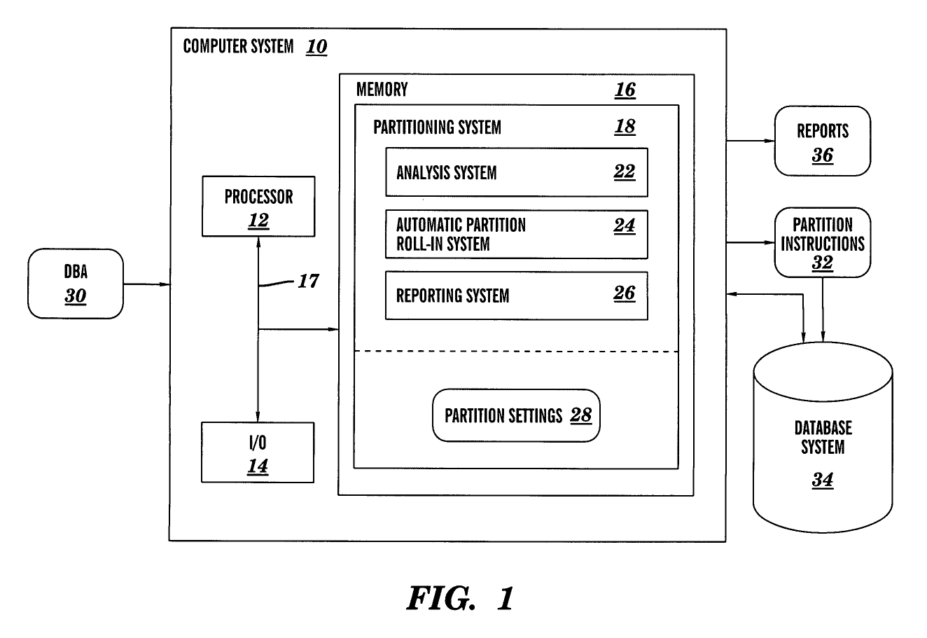

Referring to FIG. 1, a computer system 10 is shown comprising a partitioning system 18 for generating partition instructions for automatically partitioning tables in a database system 34. Note that partitioning system 18 could be fully/partially integrated into database system 34, or operate as a stand-alone system. Partitioning system 18 includes an analysis system 22 for reviewing partition settings 28 and analyzing the status of the database system 34 to determined if and when new partitions should be created. Partition settings 28 (described further below) allow the DBA 30 to predefine any number of partitioning operations that can occur in the future.

When it is determined by analysis system 22 that a new table partition is required, automatic partition roll-in system 24 generates the necessary partition instructions 32 for the database system 34. A reporting system 26 may be used to output reports, include, e.g., scheduling reports, historical reports, logs, error alerts, etc.

Consider the case of DB2 handing range based roll-ins. Automatic maintenance in DB2 is an already established technology for autonomically performing backups, RUNSTATS and REORGS during a predetermined maintenance window. Partitioning system 18 extends this functionality. For example, a data warehouse may have a rolling 53 week, 13 month, 5 quarter, or 7 year set of fact data tables. The DBA must be diligent in doing a roll-in of the new week, month, quarter or year range to these tables. Since there are so many possible kinds of partitioning schemes, the schedule for doing these roll-ins can vary greatly.

Partitioning system 18 would come into play after the warehouse loading occurs. DB2 would “notice” that the very last partition of a table now has been loaded with at least some data. This tells DB2 that sooner or later a new partition will be needed for new data, so instead of waiting for a DBA to notice this and manually roll-in the partition, DB2 would do it by itself, thereby leaving the human element out of the equation.

Consider the example of a set of sales data that has a rolling five quarters in it. The following represents how partitioning is handled manually.

CREATE TABLE SALES_YEAR(SALE_DATE DATE,
CUSTNO INT, ...)

PARTITION BY RANGE(SALE_DATE)
(
PART Q1_2006 STARTING ‘01/01/2006’ ENDING ‘03/31/2006’,
PART Q2_2006 STARTING ‘04/01/2006’ ENDING ‘06/30/2006’,
PART Q3_2006 STARTING ‘07/01/2006’ ENDING ‘09/30/2006’,
PART Q4_2006 STARTING ‘10/01/2006’ ENDING ‘12/31/2006’,
PART Q1_2007 STARTING ‘01/01/2007’ ENDING ‘03/31/2007’
);

When loading data into this partitioned table, the DBA does not have to concern himself with a roll-in of another partition until sometime near the end of the 1^{st} quarter in 2007. However, as soon as 2^{nd} quarter 2007 appears in the load files, the DBA should have done a roll-in of a new empty partition or the data will be rejected because there will be no place for it to go.

Partitioning system 18 will allow the DB2 to, e.g., “see” that data has been loaded into the Q1_{—}2007 partition, but that no Q2_{—}2007 partition exists. When it sees this scenario, it will perform the following three things automatically for the DBA:
#1—Create the table space for the supported partition (which is optional)
   CREATE LARGE TABLESPACE “SALES_YEAR_TS_Q2_{—}2007”
      PAGESIZE 16 K
      MANAGED BY AUTOMATIC STORAGE
      EXTENTSIZE 16
      OVERHEAD 10.5 PREFETCHSIZE 16 TRANSFERRATE 0.14
      BUFFERPOOL SALES_YEAR_BP;
#2—Create the temporary table from a template that the DBA created for purposes of this feature
CREATE TABLE SALES_YEAR_TEMP AS
   (SELECT*FROM SALES_YEAR_TEMPLATE)
   DEFINITION ONLY;
#3—Roll-in the new partition from the temporary table
   ALTER TABLE SALES_YEAR
      ATTACH PARTITION PART Q2_{—}2007
      IN SALES_YEAR_TS_Q2_{—}2007
      STARTING (‘04/01/2007’) ENDING (‘06/30/2007’)
   FROM SALES_YEAR_TEMP;

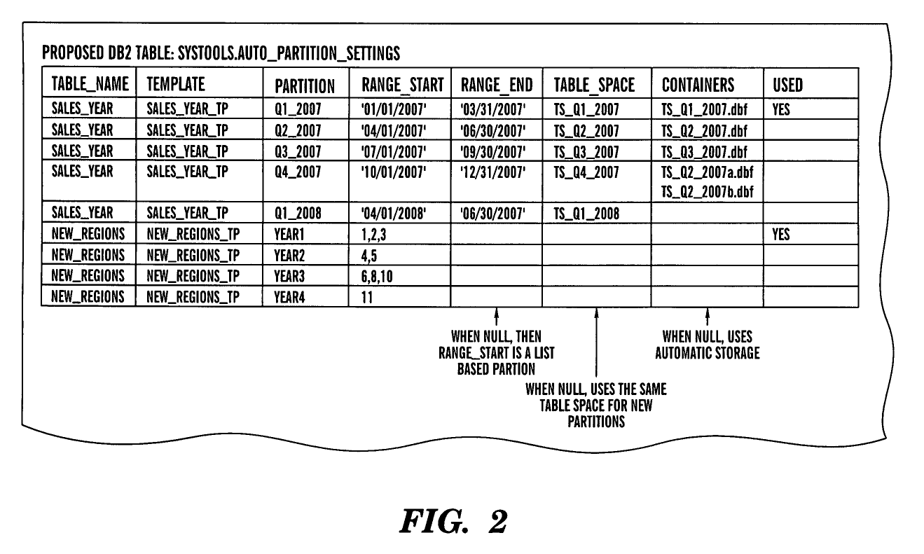

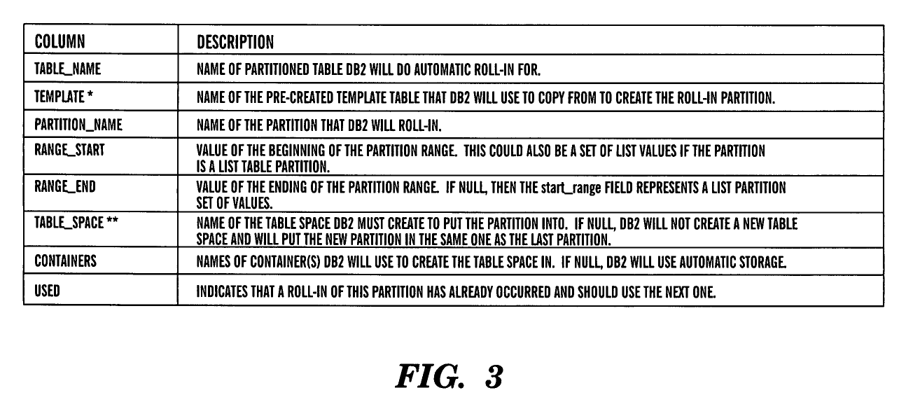

As noted, partitioning system 18 utilizes partition settings to predefine partitioning operations. In DB2, this may be done with a new systools table created by DB2, called SYSTOOLS.AUTO_PARTITION_SETTINGS in this example. An example of this table is shown in FIG. 2, and an explanation of the settings is provided in FIG. 3. This table can be generated by DB2 during the automatic maintenance GUI tool usage. It can also be pre-filled with DB2 suggestions for values based on patterns it already sees in the current partitioned tables in the database. This pattern generation would be similar to the pattern generation used by, e.g., a Lotus spreadsheet.

The DBA will review what DB2 suggests and makes any changes they may want to the values and then keep the table as part of the Automatic Table Partitioning Roll-in setup. The table itself allows the DBA to set up in detail how the partitioned tables in that database should be implemented in the future and can represent many years of roll-in actions, but not require that the DBA actually perform the roll-in at the time of the setup. The review and edit step of the generated table is necessary in case DB2 does not generate the patterns the DBA desires.

In addition to manually determining when a new table partition should occur in the future, analysis system 22 can automatically detect the need for the new partition by examining a state of the database system 34. In DB2, this may be implemented as follows. The Automatic Maintenance feature would be changed to include a selection for “Automatic Table Partitioning Roll-in”. It would just be another choice in the selection of features. When using this GUI tool, selecting “Automatic Table Partitioning Roll-in” would give the DBA the ability to: select the scope of tables that will be included in the processing along with “automate” and “notify” options; access to the setup screen that would accept input values for the table SYSTOOLS.AUTO_PARTITION_SETTINGS (FIG. 2); and create template tables (if this has not already been done).

Automatic Maintenance setting results would include:
New DB parameter auto_part: Turning on this feature would set a new DB configuration parameter auto_part=on. This parameter would be a subset of the auto_tbl_maint parameter.
Notify setting: If only “notify” is selected, then the automatic maintenance feature will only notify the DBA that partitioning is required on tables that qualify.
Automate setting: If “automate” is selected, then the automatic maintenance feature will attempt to do the roll-in of table partitions for tables that qualify. If the automatic roll-in fails for any reason, then it will fall back and notify the DBA of the failed attempt on a qualifying table.

Determining qualifying tables would done as follows. With Automatic Maintenance now having the above settings, during its maintenance window, DB2 will determine if a table “qualifies” for a new roll-in of a partition. It will do so by doing the following:
First consider the entire scope of tables and drop out any tables that are not partitioned tables. This can be done by checking the SYSCAT.DATAPARTITIONS view. Any table not listed here is not a partitioned table to begin with and so will be ignored for consideration for Automatic Table Partitioning Roll-in.
For the remaining tables, you can then derive the last allocated data partition in the partition table by checking the SYSCAT.DATAPARTITIONS view, MAX(datapartitionid) for that table.
For these same tables, derive the last used partition with MAX(DATAPARTITIONNUM (columnname)) function
If the last allocated partition in the table is the last used partition, then perform the roll-in.

Roll-in of new partition would be done as follows. Qualifying tables that require roll-in of a new partition then will able to be built by generating DDL on the fly using two main sources:
SYSTOOLS.AUTO_PARTITION_SETTINGS table gives partition name, range and other details for the partitioned table.
Table space settings that need to be determined are simply borrowed from the table space used in the last partition of that table. This is done by using the:
   SYSCAT.DATAPARTITIONS view, column TBSPACEID which give the table space ID used by the last partition.
   MAX of the DATAPARTITIONID to find which value of TBSPACEID you need to get the details for.
   SYSCAT.TABLESPACES will give all the details you need for all table space characteristics required to build the table space for the new partition.

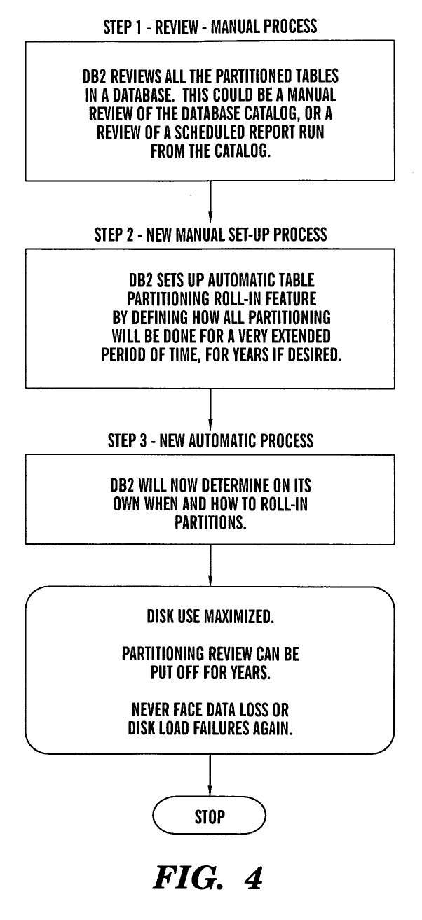

FIG. 4 depicts a method of implementing table partitioning. At step S1, the DBA reviews all the partitioned tables in a database. Next, the DBA sets up the automatic table partitioning roll-in feature using e.g., a partition settings table, such as that shown in FIG. 2. Next, the database itself determines when and how to roll-in partitions. The result is that disk use is maximized and partitioning review can be put off for years.

Referring again to FIG. 1, it is understood that computer system 10 may be implemented as any type of computing infrastructure. Computer system 10 generally includes a processor 12, input/output (I/O) 14, memory 16, and bus 17. The processor 12 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Moreover, memory 16 may reside at a single physical location, comprising one or more types of data storage, or be distributed across a plurality of physical systems in various forms.

I/O 14 may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. Bus 17 provides a communication link between each of the components in the computer system 10 and likewise may comprise any known type of transmission link, including electrical, optical, wireless, etc. Although not shown, additional components, such as cache memory, communication systems, system software, etc., may be incorporated into computer system 10.

Access to computer system 10 may be provided over a network such as the Internet, a local area network (LAN), a wide area network (WAN), a virtual private network (VPN), etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

It should be appreciated that the teachings of the present invention could be offered as a business method on a subscription or fee basis. For example, a computer system 10 comprising a partitioning system 18 could be created, maintained and/or deployed by a service provider that offers the functions described herein for customers. That is, a service provider could offer to deploy or provide the ability to table partitioning as described above.

It is understood that in addition to being implemented as a system and method, the features may be provided as a program product stored on a computer-readable medium, which when executed, enables computer system 10 to provide a partitioning system 18. To this extent, the computer-readable medium may include program code, which implements the processes and systems described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 16 and/or a storage system, and/or as a data signal traveling over a network (e.g., during a wired/wireless electronic distribution of the program product).

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that terms such as “component” and “system” are synonymous as used herein and represent any combination of hardware and/or software capable of performing some function(s).

The block diagrams in the figures illustrate the architecture, functionality, and operation of possible implementations of systems, methods and computer program products according to various embodiments of the present invention. In this regard, each block in the block diagrams may represent a module, segment, or portion of code, which comprises one or more executable instructions for implementing the specified logical function(s). It should also be noted that the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams can be implemented by special purpose hardware-based systems which perform the specified functions or acts, or combinations of special purpose hardware and computer instructions.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A partitioning system for automatically partitioning tables in a database system, comprising:
a system for analyzing a plurality of partition settings that predefines partitioning operations that need to occur in the future; and
an automatic partition roll-in system that automatically causes tables to be partitioned based on the partition settings.

2. The partition system of claim 1, wherein the partition settings are stored in a table that defines ranges for associated partitions.

3. The partition system of claim 1, wherein the partition settings are stored in a table that defines lists for associated partitions.

4. The partition system of claim 1, further comprising a system for analyzing the database system to determine when a new partition should be created.

5. The partition system of claim 1, wherein the automatic partition roll-in system includes:
a system for creating a new table space;
a system for creating a temporary table; and
a system for rolling in a new partition from the temporary table.

6. The partition system of claim 1, further comprising a system for generating proposed partition settings.

7. A computer readable medium having a computer program product for automatically partitioning tables in a database system, comprising:
program code for analyzing a plurality of partition settings that predefines partitioning operations that need to occur in the future; and
program code that automatically causes tables to be partitioned based on the partition settings.

8. The computer readable medium of claim 7, wherein the partition settings are stored in a table that defines ranges for associated partitions.

9. The computer readable medium of claim 7, wherein the partition settings are stored in a table that defines lists for associated partitions.

10. The computer readable medium of claim 7, further comprising program code for analyzing the database system to determine when a new partition should be created.

11. The computer readable medium of claim 7, wherein the program code that automatically causes tables to be partitioned includes:
program code for creating a new table space;
program code for creating a temporary table; and
program code for rolling in a new partition from the temporary table.

12. The computer readable medium of claim 7, further comprising program code for generating proposed partition settings.

13. A method for automatically partitioning tables in a database system, comprising:
receiving a plurality of partition settings that predefine partitioning operations that need to occur in the future;
analyzing the plurality of partition settings;
analyzing a state of the database system; and
automatically causing tables to be partitioned based on the partition settings and the state of the database system.

14. The method of claim 13, wherein the partition settings are stored in a table that defines ranges for associated partitions.

15. The method of claim 13, wherein the partition settings are stored in a table that defines lists for associated partitions.

16. The method of claim 13, wherein automatically causing tables to be partitioned includes:
creating a new table space;
creating a temporary table; and
rolling in a new partition from the temporary table.

17. The method of claim 13, further including generating proposed partition settings.
